(19) United States
(12) Patent Application Publication
(10) Pub. No.: US 2026/0018048 A1
(43) Pub. Date: Jan. 15, 2026

(54) ENHANCED RADAR-BASED MOTION DETECTION USING EVENT LOCATION CONFIRMATION

(71) Applicant: TEXAS INSTRUMENTS INCORPORATED, Dallas, TX (US)

(72) Inventors: Sandeep Rao, Bangalore (IN); Dan Wang, Shanghai (CN); Anil Mani, McKinney, TX (US); Bhaskar Upadhyay, Melissa, TX (US); Nathan Block, Dallas, TX (US)

(21) Appl. No.: 19/064,207

(22) Filed: Feb. 26, 2025

(30) Foreign Application Priority Data
Jul. 10, 2024 (IN) 202441052851

(51) Int. Cl. G08B 29/18; G01S 13/88; G08B 13/196

(52) U.S. Cl. CPC G08B 29/185; G01S 13/886; G08B 13/19697

(57) ABSTRACT

Various embodiments of the present disclosure relate to video surveillance systems, and in particular, to detecting movement within a scene. In one example embodiment, a technique for determining if a motion event is a false alarm event is provided. The technique first includes processing a received radar signal to detect a motion event within a scene. Next, the technique includes performing a comparison between a location of the motion event and locations of motion events previously detected within the scene. If the comparison indicates that the location of the motion event does not match the previously detected locations, then the technique includes confirming that the motion event is an actual motion event. Alternatively, if the comparison indicates that the location of the motion event matches a previously detected location, then the technique includes confirming that the motion event is a false alarm event.

### CROSS-REFERENCE TO RELATED APPLICATION

This application is related to, and claims the benefit of priority to, India Provisional Patent Application No. 202441052851, filed on Jul. 10, 2024, and entitled “False Alarm Mitigation For Camera/Radar Systems”, which is hereby incorporated by reference in its entirety.

### TECHNICAL FIELD

Aspects of the disclosure are related to the field of computing hardware and software and more particularly to radar and video surveillance systems.

### BACKGROUND

A video surveillance system is a type of surveillance technology which leverages both video and radar to prevent intruders, theft, and other dangers of the like. For example, such systems may include video doorbells which are configured to monitor for movement outside a user's front porch. Typically, video surveillance systems, such as video doorbells, include a radar device which continuously monitors for movement within a scene, and a camera subsystem which is awoken by the radar device when movement is detected within the scene.

Generally, video surveillance systems are employed to detect human motion. For example, within the context of video doorbell systems, a video doorbell may be configured to alert a user that movement was detected within a scene when both the radar device and the camera subsystem detect human motion within the scene. Problematically, the radar devices which are currently employed by such systems are unable to distinguish between different types of motion and are prone to waking up the camera subsystem when non-human motion is detected. Consequently, video doorbell systems are battery operated, and as a result, false alarms due to non-human motion increase the power consumption of the system, thereby wasting the processing resources of the system.

For example, after the radar device of a video doorbell detects movement using both low-power and high-power radar signals, the radar device instructs the camera subsystem of the video doorbell to begin capturing the detected movement. In response, the camera subsystem begins collecting image data of the scene to determine if the detected movement was human or non-human motion. In either case, the camera subsystem must waste power resources of the video doorbell to determine if the detected movement was a false alarm, thusly reducing the lifespan of the video doorbell.

### SUMMARY

Disclosed herein is technology, including systems, methods, and devices for detecting movement within the context of a video surveillance system. In various implementations, a technique for processing radar signals to determine if a motion event is a false alarm event is provided.

In one example embodiment, the technique first includes processing a received radar signal to detect a motion event within a scene. For example, the scene may include a user's front porch, such that the motion event is movement which occurred on the front porch. Next, the technique includes performing a comparison between a location of the motion event and locations of motion events previously detected within the scene to determine whether the detected motion event is one of interest. For example, the technique may include comparing the location of the motion event to locations of motion events which have been previously confirmed as false alarm events.

Finally, the technique includes confirming whether the motion event is a motion event of interest based on a result of the comparison. For example, if the comparison indicates that the location of the motion event does not match the locations of the previously detected motion events previously confirmed as false alarm events, then the technique includes confirming that the motion event is an actual motion event. Alternatively, if the comparison indicates that the location of the motion event matches a location of a previously detected motion event, then the technique includes confirming that the motion event is a false alarm event.

This Summary is provided to introduce a selection of concepts in a simplified form that are further described below in the Detailed Description. It may be understood that this Summary is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment in an implementation.

FIG. 2 illustrates a detection method in an implementation.

FIGS. 3A and 3B illustrate a system in an implementation.

FIGS. 4A and 4B illustrate operational sequences in an implementation.

FIG. 5 illustrates a detection process in an implementation.

FIG. 6 illustrates a detection scenario in an implementation.

FIG. 7 illustrates another detection scenario in an implementation.

### DETAILED DESCRIPTION

Technology is disclosed herein for detecting motion within the context of video surveillance systems which reduces the power consumption of the associated system. For example, such systems may include video doorbell systems which leverage both video and radar to detect motion. For the purposes of explanation, video doorbell systems will be discussed herein. This is not meant to limit the applications of the proposed technology, but rather to provide an example. Other applications may include residential security systems, commercial security systems, traffic/vehicle operating environments, industrial environments, zoo/nature environments or other systems or environments of the like which require video surveillance.

Generally, video doorbell systems include a radar device which continuously monitors for motion within a designated region of interest (ROI), and a camera subsystem which is awoken by the radar device when motion is detected within the designated ROI. The designated ROI is a section within a scene in which a user requests direct surveillance, such that the scene is the environment that is being monitored by the video doorbell. For example, the scene may include a user's front porch, while the designated ROI is a section of the porch in which the user desires direct surveillance.

Existing techniques for detecting motion within the context of a video doorbell system employ a radar device to detect a specific type of motion. For example, such systems may be employed to detect human motion such as package theft, intruders, and other dangers of the like. Problematically, the radar devices currently utilized by video doorbell systems are unable to discern between different types of motion (i.e., human motion versus non-human motion), and as a result, wake up the camera subsystem in response to any type of detected motion. For example, after the radar device of a video doorbell system configured to detect human motion confirms that motion was detected within the designated ROI, the radar device is configured to wake up the camera subsystem. Once awoken, the camera subsystem is configured to collect image data of the scene to determine if the detected motion was either human motion or non-human motion.

Currently, video doorbell systems are battery operated, such that the batteries of such systems are expected to last for approximately 6-12 months. Problematically, existing techniques for detecting motion within such systems require the camera subsystem to perform extra processing to determine if the detected motion was a false alarm. As a result, existing techniques for detecting motion within video doorbell systems depletes the power resources of the associated system, and in turn, reduces the lifespan of the video doorbell. In contrast, disclosed herein is a new technique for detecting motion within the context of video doorbell systems, which relies on feedback information for identifying false alarms, and by design, preserves the power consumption of the associated system.

In one example embodiment, a technique for detecting motion within the context of a video doorbell is provided. The technique may be employed by processing circuitry to cause the processing circuitry to detect motion within a scene, and to determine if the detected motion was a false alarm. For example, the technique may cause the processing circuitry to determine if the detected motion was human motion or non-human motion.

In an implementation, the technique first causes the processing circuitry to process a received radar signal to detect a motion event within a scene. For example, the scene may include a user's front porch, and the received radar signal may include a received low-power radar signal which stores data related to the motion event (i.e., movement) that occurred on the user's front porch. Next, the technique includes performing a comparison between a location of the motion event and locations of motion events previously detected within the scene. For example, after receiving the low-power radar signal, the processing circuitry may be configured to process the low-power radar signal to determine a location of the motion event. Once determined, the processing circuitry may compare the location of the motion event to locations of motion events which have been previously confirmed as false alarm events. In an implementation, the locations of the previously confirmed false alarm events are stored in an associated feedback buffer. For example, the processing circuitry may include a buffer configured to store data related to the previously confirmed false alarm events.

Next, the processing circuitry is configured to initially classify the motion event as a false alarm event or a motion event of interest (potential motion event) based on a result of the comparison. For example, if the comparison indicates that the location of the motion event matches a location of a previously confirmed false alarm event, then the processing circuitry is configured to classify the motion event as corresponding to a previously confirmed false alarm event, and in response, return to transmitting and receiving radar signals across the scene. Alternatively, if the comparison indicates that the location of the motion event does not match the locations of the previously confirmed false alarm events, then the technique includes classifying the motion event as a potential motion event.

In an implementation, if the processing circuitry initially classifies the motion event as a potential motion event, then the processing circuitry is configured to confirm whether that initial classification is correct. For example, after classifying the motion event as a potential motion event based on a received low-power radar signal, the processing circuitry may be configured to redetect the motion event based on a received high-power radar signal to confirm whether the motion event is a potential motion event. If the processing circuitry redetects the motion event as a potential motion event based on a received high-power radar signal, then the processing circuitry is configured to confirm the motion event is an actual motion event (i.e., motion event of interest), and in response, wake up an associated camera subsystem to cause the associated camera subsystem to collect image data of the actual motion event. For example, the processing circuitry may be coupled to a camera subsystem, that when instructed, is configured to collect image data of a scene and process the collected image data to determine if the actual motion event is a new false alarm event, i.e., a false alarm event not previously confirmed as such. In an implementation, when instructed by the processing circuitry, the associated camera subsystem is configured to transition from an off-state to an on-state, such that when in the on-state, the associated camera subsystem is configured to collect image data of the actual motion event to determine if the image data depicts a new false alarm event.

For example, if the processing circuitry is configured to detect human motions as motions of interest, then the associated camera subsystem is configured to determine if the actual motion event depicts human or non-human motion. In an implementation, if the camera subsystem determines that the actual motion event is a human motion event, then the processing circuitry is configured to notify an associated user of the human motion event. For example, the processing circuitry may send an alert to an end-user device that human motion was detected in the user designated ROI.

Alternatively, if the camera subsystem determines that the actual motion event is a non-human motion event, then the camera subsystem is configured to confirm the actual motion event as a new false alarm event. In an implementation, if the camera subsystem determines that the actual motion event is a new false alarm event, then the camera subsystem is configured to collect feedback information related to the new false alarm event. For example, the feedback information may include a location of the new false alarm event and a signal-to-noise ratio (SNR) of the new false alarm event. The SNR information is obtained from analysis of the low-power radar signal and/or the high-power radar signal. In an implementation, the camera subsystem is configured to store the feedback information in the feedback buffer. For example, the camera subsystem may provide the feedback information for the new false alarm event to the processing circuitry, and in response, the processing circuitry may store the feedback information within its buffer.

Advantageously, the proposed technology provides a technique for detecting motion within the context of video doorbell systems which mitigates the number of times the camera subsystem is awoken. As such, the proposed technology provides a technique for detecting motion which reduces the power consumption of the associated system. As a result, the proposed technology provides a technique which increases the lifespan of video doorbell systems.

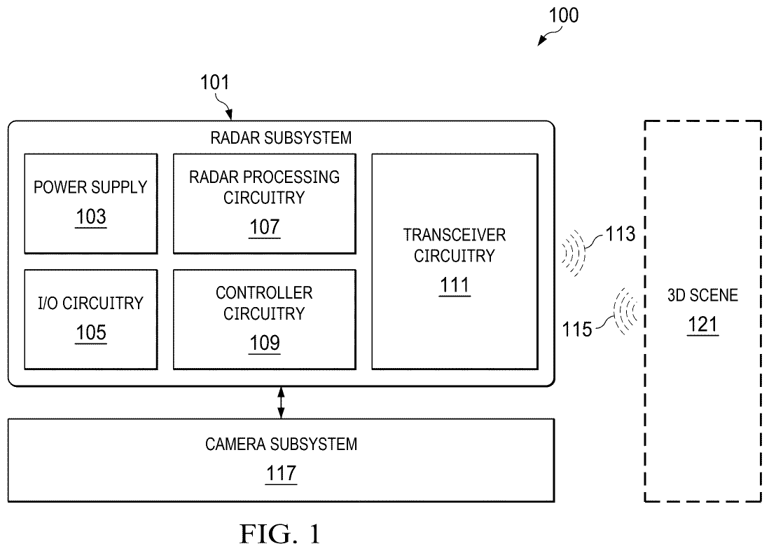

Turning now to the figures, FIG. 1 illustrates operating environment 100 in an implementation. Operating environment 100 is representative of an exemplary video surveillance system configured to detect motion. For example, operating environment 100 may be representative of a video doorbell system which leverages both radar and video to detect motion. Operating environment 100 includes radar subsystem 101, camera subsystem 117, and 3D scene 121. In some examples, radar subsystem 101 and camera subsystem 117 form a radar/camera system.

Radar subsystem 101 is representative of one or more circuits configured to collect and process radar data of an associated environment. For example, radar subsystem 101 may be representative of a device configured to transmit and receive radar signals across 3D scene 121. In an implementation, radar subsystem 101 operates under two different modes. The first mode, herein referred to as the low-power mode, describes an operating mode where radar subsystem 101 transmits and receives low-power radar signals. Alternatively, the second operating mode, herein referred to as the high-power mode, describes an operating mode where radar subsystem 101 transmits and receives high-power radar signals.

In an implementation, radar subsystem 101 is configured to determine when to wake up camera subsystem 117. For example, radar subsystem 101 may be configured to determine if motion was detected within 3D scene 121 based on received low-power and high-power radar signals, and in response, determine to wake up camera subsystem 117. As used herein, the term “wake up” includes turning on, activating, or otherwise transitioning the camera subsystem (e.g., camera subsystem 117) from an off-state, low-power state, or sleep-state to an operative state. Radar subsystem 101 includes, but is not limited to, power supply 103, input/output (I/O) circuitry 105, radar processing circuitry 107, controller circuitry 109, and transceiver circuitry 111.

Power supply 103 is representative of circuitry configured to provide power to radar subsystem 101. For example, power supply 103 may supply power to radar processing circuitry 107, I/O circuitry 105, controller circuitry 109, and transceiver circuitry 111. In an implementation, power supply 103 includes multiple power supply rails for providing various levels of power. For example, power supply 103 may include a 1.2 voltage supply rail, a 1.8 voltage supply rail, and a 3.3 voltage supply rail.

I/O circuitry 105 is representative of circuitry configured to provide input pins and output pins to radar subsystem 101. For example, an external device may either deliver signals to or receive signals from radar subsystem 101 via I/O circuitry 105. In an implementation, I/O circuitry 105 includes, but is not limited to, quad serial peripheral interface (QSPI) pins, serial peripheral interface (SPI) pins, controller area network flexible data-rate (CAN-FD) interface pins, universal asynchronous receiver/transmitter (UART) pins, inter-integrated circuit (I2C) interface pins, pulse-width modulation (PWM) pins, joint test action group (JTAG) pins, and general-purpose input/output (GPIO) pins.

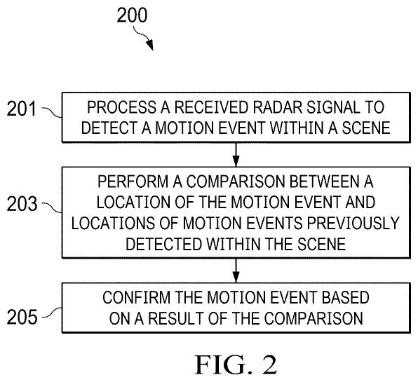

Radar processing circuitry 107 is representative of one or more processing units capable of executing program instructions. For example, radar processing circuitry 107 may be representative of a central processing unit (CPU), microcontroller unit (MCU), application-specific integrated circuit (ASIC), digital signal processor (DSP), or another processing unit of the like configured to execute program instructions. In an implementation, radar processing circuitry 107 is configured to determine if detected motion is a false alarm. For example, radar processing circuitry 107 may be configured to perform a comparison operation between the data of a newly detected motion event and the data of previously detected false alarm events to determine if the newly detected motion event is representative of a previously detected false alarm event, later discussed in detail with reference to FIG. 2. In an implementation, radar processing circuitry 107 is coupled to controller circuitry 109 and is configured to drive controller circuitry 109. In some examples, a false alarm event is non-human motion, e.g., doorbell operating environment, surveillance, building security, etc., and in other examples, a false alarm event may be a different type of motion event, e.g., non-vehicle motion in a traffic/vehicle operating environment, non-animal motion in a zoo setting. In general, a false alarm event is any motion event that is not of interest in the particular application.

Controller circuitry 109 is representative of circuitry configured to manage the radar signals which are both sent and received by radar subsystem 101. For example, controller circuitry 109 may be configured to direct transceiver circuitry 111 to operate under the low-power mode or the high-power mode. When operating under the low-power mode, controller circuitry 109 directs transceiver circuitry 111 to periodically transmit a low-power energy signal across 3D scene 121. Alternatively, when operating under the high-power mode, controller circuitry 109 directs transceiver circuitry 111 to transmit high-power energy signals across 3D scene 121. In an implementation, controller circuitry 109 directs transceiver circuitry 111 to operate under the low-power mode until instructed by radar processing circuitry 107 to transition to the high-power mode.

Transceiver circuitry 111 is representative of circuitry configured to transmit and receive radar signals. For example, transceiver circuitry 111 may be coupled to an antenna configured to transmit radar signal 113, and in response, receive radar signal 115. Radar signals 113 and 115 may be representative of either low-power radar signals or high-power radar signals. For example, if transceiver circuitry 111 is operating under the low-power mode, then radar signals 113 and 115 are low-power radar signals. Alternatively, if transceiver circuitry 111 is operating under the high-power mode, then radar signals 113 and 115 are high-power radar signals. In an implementation, transceiver circuitry 111 is configured to deliver the data of radar signal 115 to controller circuitry 109. In response, controller circuitry 109 routes the data to radar processing circuitry 107 to cause radar processing circuitry 107 to analyze the data of radar signal 115. For example, radar processing circuitry 107 may determine to wake up camera subsystem 117 based on the data of radar signal 115.

Camera subsystem 117 is representative of one or more circuits configured to collect image or video data of an environment. In some examples, the circuit(s) of camera subsystem 117 may be embodied in a single device, e.g., a camera. For example, camera subsystem 117 may be configured to collect image or video data of 3D scene 121. In an implementation, camera subsystem 117 operates under two different modes, such that the two different modes include a sleep mode and an awake mode. The sleep mode describes an off-state or low-power state in which camera subsystem 117 does not collect any image data. Alternatively, the awake mode describes an on-state where camera subsystem 117 is collecting image data of scene 121.

In an implementation, camera subsystem 117 is configured to determine whether a motion event detected and classified as a potential motion event by radar subsystem 101 is an actual motion event (motion event of interest) or a false alarm event. For example, after being instructed by radar processing circuitry 107 to transition from the sleep mode to the awake mode, camera subsystem 117 may be configured to collect image data of the potential motion event within 3D scene 121. Once collected, camera subsystem 117 may process the collected image data via image processing algorithms to determine whether the potential motion event is a false alarm event. For example, if operating environment 100 is configured to detect human motion as the motion of interest, then camera subsystem 117 may be configured to determine if the motion event detected by radar subsystem 101 is human motion or non-human motion.

In an implementation, if camera subsystem 117 determines a motion event is a false alarm event, then camera subsystem 117 is configured to provide feedback information of the false alarm event to radar subsystem 101. For example, radar subsystem 101 may include a feedback buffer (not shown) configured to store the locations within 3D scene 121 where the false alarm events occurred.

3D scene 121 is representative of an environment in which a user desires surveillance. For example, in the context of video doorbell applications, 3D scene 121 may depict a user's front porch or front lawn. As such, 3D scene 121 typically includes an outdoor environment.

FIG. 2 illustrates detection method 200 in an implementation. Detection method 200 is representative of a process for detecting motion within an environment. Detection method 200 may be implemented in the context of program instructions that, when executed by a suitable computing system, direct the processing circuitry of the computing system to operate as follows, referring parenthetically to the steps in FIG. 2. For the purposes of explanation, detection method 200 will be explained with the elements of FIG. 1. This is not meant to limit the applications of detection method 200, but rather to provide an example.

To begin, controller circuitry 109 directs transceiver circuitry 111 to operate under the low-power mode, and in response, transceiver circuitry 111 begins transmitting and receiving low-power radar signals. For example, transceiver circuitry 111 may transmit radar signal 113 across 3D scene 121, and in response, receive radar signal 115, such that radar signals 113 and 115 are low-power radar signals. Next, transceiver circuitry 111 is configured to supply the received low-power radar signal to controller circuitry 109 to cause controller circuitry 109 to route the data of the received low-power radar signal to radar processing circuitry 107. Once received, radar processing circuitry 107 is configured to process the received low-power radar signal to determine if a motion event occurred within 3D scene 121 (step 201).

For example, radar processing circuitry 107 may include an analog front-end and a digital front-end configured to extract data from the received low-power radar signal and suitably process the extracted data using signal processing algorithms (e.g., fast Fourier transforms (FFTs), detection algorithms, and other algorithms of like as known in the art) to determine if a motion event occurred. If radar processing circuitry 107 determines that no motion event occurred, then radar processing circuitry 107 is configured to instruct controller circuitry 109 to cause transceiver circuitry 111 to continue to operate under the low-power mode. Alternatively, if radar processing circuitry 107 determines that a motion event occurred, then radar processing circuitry 107 is configured to extract data related to the motion event from the received low-power radar signal to determine if the motion event is a false alarm event or a potential motion event. For example, radar processing circuitry 107 may extract a location of the motion event and a SNR of the motion event from the received low-power radar signal. Once extracted, radar processing circuitry 107 may perform a comparison between the data of the motion event and the data of false alarm events which were previously detected within 3D scene 121 (step 203).

In an implementation, to perform the comparison, radar processing circuitry 107 is configured to compare the data of the motion event to data stored by the feedback buffer of radar subsystem 101. The feedback buffer is representative of a buffer which is configured to store data related to previously detected false alarm events. For example, the feedback buffer may store the locations of the previously detected false alarm events and the SNRs of the previously detected false alarm events. As such, to perform the comparison, radar processing circuitry 107 is configured to compare the location of the motion event with the locations stored by the feedback buffer. In addition, radar processing circuitry 107 may be configured to compare the SNR of the motion event with the SNRs stored by the feedback buffer.

Next, radar processing circuitry 107 is configured to confirm that the motion event is either a false alarm event or a potential motion event based on a result of the comparison (step 205). For example, if radar processing circuitry 107 determines that the data of the motion event matches data stored by the feedback buffer, then radar processing circuitry 107 is configured to confirm that the motion event is a false alarm event. In an implementation, if radar processing circuitry 107 confirms that the motion event is a false alarm event, then radar processing circuitry 107 is configured to instruct controller circuitry 109 to cause transceiver circuitry 111 to continue to operate under the low-power mode. Alternatively, if radar processing circuitry 107 determines that the data of the motion event does not match the data stored by the feedback buffer, then radar processing circuitry 107 is configured to confirm that the motion event is a potential motion event.

In an implementation, if radar processing circuitry 107 confirms that the motion event is a potential motion event, then radar processing circuitry 107 is configured to instruct controller circuitry 109 to cause transceiver circuitry 111 to enter the high-power mode. In response, transceiver circuitry 111 transmits and receives high-power radar signals, and provides the received high-power radar signals to controller circuitry 109. Controller circuitry 109 routes the received high-power radar signals to radar processing circuitry 107 to cause radar processing circuitry 107 to confirm the potential motion event based on received high-power radar signals. In an implementation, if radar processing circuitry 107 does not confirm the potential motion event based on the received high-power radar signals, then radar processing circuitry 107 is configured to instruct controller circuitry 109 to transition transceiver circuitry 111 back to the low-power mode.

Alternatively, if radar processing circuitry 107 confirms the motion event based on the received high-power radar signals, then radar processing circuitry 107 is configured to classify the potential motion event as an actual motion event, and in response, wake up camera subsystem 117. For example, radar processing circuitry 107 may send a wake-up signal to camera subsystem 117 to cause camera subsystem 117 to transition from the sleep mode to the awake mode and begin collecting image data of 3D scene 121. In an implementation, radar processing circuitry 107 is further configured to send the location of the actual motion event to camera subsystem 117. For example, radar processing circuitry 107 may send the location of the actual motion event to camera subsystem 117, and in response, camera subsystem 117 begins collecting image data of the location.

In an implementation, camera subsystem 117 is configured to process the collected image data to determine whether the classification by the radar processing circuitry 107 of the motion event as an actual motion event is correct or represents a new false alarm event. For example, if operating environment 100 is configured to detect human motions, then camera subsystem 117 may include image processing algorithms (e.g., convolutional neural networks), that when executed, cause camera subsystem 117 to determine if the actual motion event detected by radar subsystem 101 depicts human or non-human motion.

If camera subsystem 117 determines the actual motion event is not a new false alarm event, then camera subsystem 117 is configured to stream the collected image data of the actual motion event to an end-user device. Alternatively, if camera subsystem 117 determines the actual motion event is a new false alarm event, then camera subsystem 117 is configured to provide feedback information of the new false alarm event to radar subsystem 101. For example, camera subsystem 117 may store a location of the new false alarm event within the feedback buffer of radar subsystem 101, which new false alarm event may be associated with an SNR that is obtained from radar signal analysis. Once stored, radar processing circuitry 107 may utilize the feedback information generated by camera subsystem 117 to determine if future motion events are false alarm events.

Advantageously, detection method 200 provides a technique for determining if a motion event is a false alarm event based on the data stored by the feedback buffer. As such, detection method 200 provides a technique for detecting motion within an environment which minimizes the number of times that camera subsystem 117 is awoken. As a result, detection method 200 provides a technique which reserves the power consumption of video surveillance systems, thereby increasing the lifespan of such systems.

While detection method 200 was discussed within the context of a radar device that is capable of operating in a low-power mode and a high-power mode, it may be appreciated that detection method 200 may be implemented within the context of a system where the radar device exclusively operates in a high-power mode. For example, controller circuitry 109 may direct transceiver circuitry 111 to begin transmitting and receiving high-power radar signals across 3D scene 121 and supply the received high-power radar signals to controller circuitry 109. In response, controller circuitry 109 routes the data of the received high-power radar signals to radar processing circuitry 107 to cause radar processing circuitry 107 to process the received high-power radar signal to determine if a motion event occurred within 3D scene 121 (step 201).

If radar processing circuitry 107 determines that no motion event occurred, then radar processing circuitry 107 is configured to instruct controller circuitry 109 to cause transceiver circuitry 111 to continue to transmit and receive high-power radar signals. Alternatively, if radar processing circuitry 107 determines that a motion event occurred, then radar processing circuitry 107 is configured to extract data related to the motion event from the received high-power radar signal to determine if the motion event is a false alarm event. For example, radar processing circuitry 107 may extract a location of the motion event and a SNR of the motion event from the received high-power radar signal and perform a comparison between the data of the motion event and the data stored by the feedback buffer (step 203).

Next, radar processing circuitry 107 is configured to confirm that the motion event is either a false alarm event or an actual motion event based on a result of the comparison (step 205). For example, if radar processing circuitry 107 determines that the data of the motion event matches data stored by the feedback buffer, then radar processing circuitry 107 is configured to confirm that the motion event is a false alarm event. Alternatively, if radar processing circuitry 107 determines that the data of the motion event does not match the data stored by the feedback buffer, then radar processing circuitry 107 is configured to confirm that the motion event is an actual motion event.

In an implementation, if radar processing circuitry 107 confirms that the motion event is an actual motion event, then radar processing circuitry 107 is configured to wake up camera subsystem 117. For example, radar processing circuitry 107 may send a wake-up signal to camera subsystem 117 to cause camera subsystem 117 to transition from the sleep mode to the awake mode and begin collecting image data of 3D scene 121. In an implementation, camera subsystem 117 is configured to process the collected image data to determine if the actual motion event is a new false alarm event.

If camera subsystem 117 determines the actual motion event is not a new false alarm event, then camera subsystem 117 is configured to stream the collected image data of the actual motion event to an end-user device. Alternatively, if camera subsystem 117 determines the actual motion event is a new false alarm event, then camera subsystem 117 is configured to provide feedback information of the new false alarm event to radar subsystem 101. For example, camera subsystem 117 may store a location of the new false alarm event in association with an SNR of the new false alarm event within the feedback buffer of radar subsystem 101. Once stored, radar processing circuitry 107 may utilize the feedback information generated by camera subsystem 117 to determine if future motion events are false alarm events.

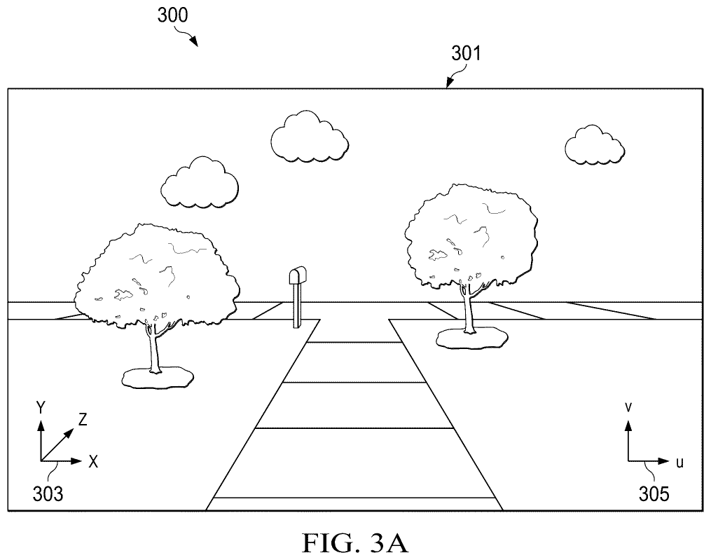

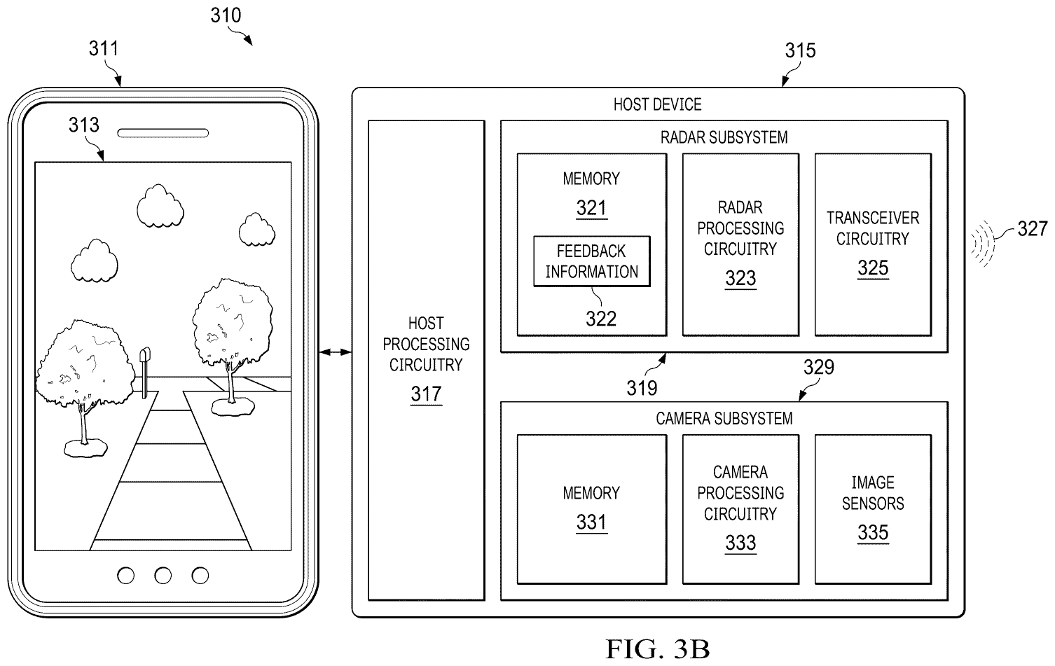

FIGS. 3A and 3B illustrate a system in an implementation, such that FIG. 3A illustrates system environment 300 in an implementation, and FIG. 3B illustrates system 310 in an implementation. System environment 300 is representative of an exemplary surveillance environment, while system 310 is representative of an exemplary surveillance system configured to detect movement within system environment 300. For example, system environment 300 may depict a user's front lawn, while system 310 is a video doorbell configured to detect motion which occurs on the user's front lawn. For the purposes of explanation, system 310 is configured to detect human motion. This specification is not meant to limit the applications of system 310, but rather to provide an example.

Now turning to FIG. 3A, system environment 300 includes scene 301. Scene 301 is representative of an environment in which a user desires surveillance. For example, scene 301 may include 3D scene 121 of FIG. 1. In an implementation, scene 301 represents the image which is displayed to an end-user device. For example, when system 310 detects human motion within scene 301, system 310 is configured to stream scene 301 to end-user device 311, later discussed in detail with reference to FIG. 3B. Scene 301 includes 3D coordinate axis 303 and 2D coordinate axis 305.

3D coordinate axis 303 is representative of an axis which describes the 3D real-world coordinates depicted in scene 301 (i.e., (X,Y,Z)). In an implementation, the radar subsystem of system 310 is configured to utilize 3D coordinate axis 303 to identify the 3D real-world coordinates of various radar reflections. For example, the radar subsystem of system 310 may utilize 3D coordinate axis 303 to determine the 3D real-world location of detected motion within scene 301.

2D coordinate axis 305 is representative of an axis which describes the 2D image coordinates depicted in scene 301 (i.e., (u,v)). In an implementation, the camera subsystem of system 310 is configured to utilize 2D coordinate axis 305 to identify the 2D image coordinates of various detected movements. For example, the camera subsystem of system 310 may utilize 2D coordinate axis 305 to identify the 2D image location of detected motion within scene 301.

Now turning to FIG. 3B, system 310 includes end-user device 311 and host device 315. End-user device 311 is representative of a device in which a user may interact with. For example, end-user device 311 may include a mobile phone which allows a user to communicate with host device 315. It should be noted that end-user device 311 is representative of an exemplary user device. As such, end-user device 311 may be representative of a phone, laptop, tablet, or another user device of the like. In an implementation, end-user device 311 is configured to stream video of scene 301 to an associated user. For example, when human motion is detected within scene 301 by host device 315, host device 315 is configured to provide video data of the human motion to end-user device 311 for access by the associated user. End-user device 311 includes, but is not limited to, user interface 313.

User interface 313 is representative of an interface that a user may interact with. For example, a user may utilize user interface 313 to designate an ROI within scene 301 in which the user requests direct surveillance by host device 315. In another example, a user may further utilize user interface 313 to designate regions of non-interest. A region of non-interest describes a user designated section within scene 301 in which a user does not desire surveillance. For example, the regions of non-interest may include sections within scene 301 where the user expects false detections to arise. In an implementation, user interface 313 is further representative of an interface which provides video data to an associated user. For example, when host device 311 detects human motion within the designated ROI, host device 311 is configured to stream data of the human motion to user interface 313.

Host device 315 is representative of one or more circuits configured to detect human motion within a scene. For example, host device 315 may be representative of a video doorbell system that is configured to leverage both radar and video to detect human motion. For the purposes of explanation, host device 315 represents a video doorbell. This is not meant to limit the applications of host device 315, but rather to provide an example. As such, host device 315 may be representative of any surveillance system configured to leverage both radar and video to detect motion within an environment. Host device 315 includes, but is not limited to, host processing circuitry 317, radar subsystem 319, and camera subsystem 329.

Host processing circuitry 317 is representative of one or more circuits configured to execute program code. For example, host processing circuitry 317 may be representative of a CPU, MCU, ASIC, or another processing device of the like configured to execute program code. In an implementation, host processing circuitry 317 is configured to provide access to a computer network. For example, host device 315 may communicate to end-user device 311 by way of host processing circuitry 317. In an implementation, host processing circuitry 317 is also configured to manage the communication between the components of host device 315. For example, host processing circuitry 317 may alert camera subsystem 329 to begin recording scene 301 when directed by radar subsystem 319.

Radar subsystem 319 is representative of one or more circuits configured to detect movement via radar. For example, radar subsystem 319 may depict radar subsystem 101 of FIG. 1. In an implementation, radar subsystem 319 operates under two different operative modes, including a low-power mode and a high-power mode. When operating under the low-power mode, radar subsystem 319 is configured to transmit and receive low-power radar signals, such that a low-power radar signal is a short, low-energy signal which comprises a limited number of chirps. Alternatively, when operating under the high-power mode, radar subsystem 319 is configured to transmit and receive high-power radar signals, such that a high-power radar signal is a longer, high-energy signal which comprises a larger number of chirps. In an implementation, radar subsystem 319 is automatically configured to operate under the low-power mode. For example, radar subsystem 319 may be configured to operate under the low-power mode until a motion event is detected. Once detected, radar subsystem 319 may transition from the low-power mode to the high-power mode. Radar subsystem 319 includes, but is not limited to, memory 321, radar processing circuitry 323, and transceiver circuitry 325.

Memory 321 is representative of one or more volatile or non-volatile computer-readable storage media including instructions, data, and the like. For example, memory 321 may be representative of static random-access memory (SRAM), dynamic random-access memory (DRAM), flash memory, or another memory of the like configured to store the data for radar subsystem 319. In an implementation, memory 321 includes feedback information buffer 322. Feedback information buffer 322 is representative of a buffer configured to store data related to previously detected false alarm events. For example, feedback information buffer 322 may store the 3D real-world locations of previously detected non-human motions and the associated SNRs of the previously detected non-human motions.

In an implementation, feedback information buffer 322 is populated by radar processing circuitry 323 and camera processing circuitry 333. For example, after determining that a potential motion event is a non-human motion event (i.e., false alarm event), radar processing circuitry 323 and camera processing circuitry 333 are configured to store the data of the non-human motion event within feedback information buffer 322. In an implementation, radar subsystem 319 includes timer circuitry (not shown) configured to clear out data from feedback information buffer 322. For example, radar processing circuitry 323 of radar subsystem 319 may include timer circuitry configured to determine how long feedback information buffer 322 has stored data for a specific non-human motion event, and after a certain amount of time (e.g., ten minutes), delete the data from feedback information buffer 322.

Radar processing circuitry 323 is representative of one or more processing units configured to execute program instructions. For example, radar processing circuitry 323 may be representative of radar processing circuitry 107 of FIG. 1. In an implementation, radar processing circuitry 323 is configured to determine if a detected motion event is a false alarm event. For example, radar processing circuitry 323 may be configured to perform a comparison operation between data of a newly detected motion event and the data stored by feedback information buffer 322, to determine if the data of the newly detected motion event matches data of previously detected non-human motion events.

In an implementation, if radar processing circuitry 323 determines that the data of the newly detected motion event matches data stored by feedback information buffer 322, then radar processing circuitry 323 is configured to classify the newly detected motion event as a false alarm event, since the detected motion event corresponds to a previously detected non-human motion event. Alternatively, if radar processing circuitry 323 determines that the data of the newly detected motion event does not match the data stored by feedback information buffer 322, then radar processing circuitry 323 is configured to classify the newly detected motion event as a potential human motion event, and in response, instruct transceiver circuitry 325 to transition from the low-power mode to the high-power mode.

Transceiver circuitry 325 is representative of circuitry (e.g., transceiver circuitry 111) configured to transmit and receive radar signals. For example, transceiver circuitry 325 may be configured to transmit radar signal 327 across scene 301, and in response, receive radar reflections which are transmitted back towards host device 315. In an implementation, transceiver circuitry 325 is configured to operate under the low-power mode until instructed to do otherwise by radar processing circuitry 323. For example, prior to detecting a motion event, transceiver circuitry 325 is configured to transmit and receive low-power radar signals and provide the received low-power radar signals to radar processing circuitry 323. Radar processing circuitry 323 then evaluates the data of the low-power radar signals to determine if a motion event occurred within scene 301.

If radar processing circuitry 323 determines that no motion events occurred, then radar processing circuitry 323 is configured to instruct transceiver circuitry 325 to remain in the low-power mode, and in response, transceiver circuitry 325 continues to transmit and receive low-power radar signals. Alternatively, if radar processing circuitry 323 determines that a motion event occurred, then radar processing circuitry 323 is configured to determine if the motion event is representative of a potential human motion event by performing a comparison between the data of the motion event and the data stored by feedback information buffer 323.

If radar processing circuitry 323 determines that the data of the motion event matches data stored by feedback information buffer 322, then radar processing circuitry 323 is configured to instruct transceiver circuitry 325 to remain in the low-power mode. Alternatively, if radar processing circuitry 323 determines that the data of the motion event does not match the data stored by feedback information buffer 322, then radar processing circuitry 323 is configured to instruct transceiver circuitry 325 to transition to the high-power mode, and in response, transceiver circuitry 325 begins transmitting and receiving high-power radar signals. In an implementation, transceiver circuitry 325 remains in the high-power mode until instructed by radar processing circuitry 323 to transition back to the low-power mode. For example, after camera subsystem 329 determines that the motion event is either a human motion event or a non-human motion event, radar processing circuitry 323 is configured to instruct transceiver circuitry to reenter the low-power mode.

Camera subsystem 329 is representative of one or more circuits (e.g., camera subsystem 117) configured to collect image or video data of an environment. Camera subsystem 329, like camera subsystem 117, may be a single device. For example, camera subsystem 329 may be configured to collect image data of scene 301 and provide the image data to end-user device 311 via host processing circuitry 317. In an implementation, camera subsystem 329 operates under two different operative modes. The first mode, herein referred to as the sleep mode, describes a mode where camera subsystem 329 is within an off-state. For example, the sleep mode may describe a state where camera subsystem 329 is not collecting any image data. Alternatively, the second mode, herein referred to as the awake mode, describes a mode where camera subsystem 329 is within an on-state. For example, the awake mode may describe a state where camera subsystem 329 is collecting image data.

In an implementation, camera subsystem 329 remains in the sleep mode until instructed by radar subsystem 319 to transition to the awake mode. For example, radar subsystem 319 may instruct camera subsystem 329 to transition from the sleep mode to the awake mode when radar processing circuitry 323 confirms that the data of a newly detected motion event does not match the data stored within feedback information buffer 322. Camera subsystem 329 includes, but is not limited to, memory 331, camera processing circuitry 333, and image sensors 335.

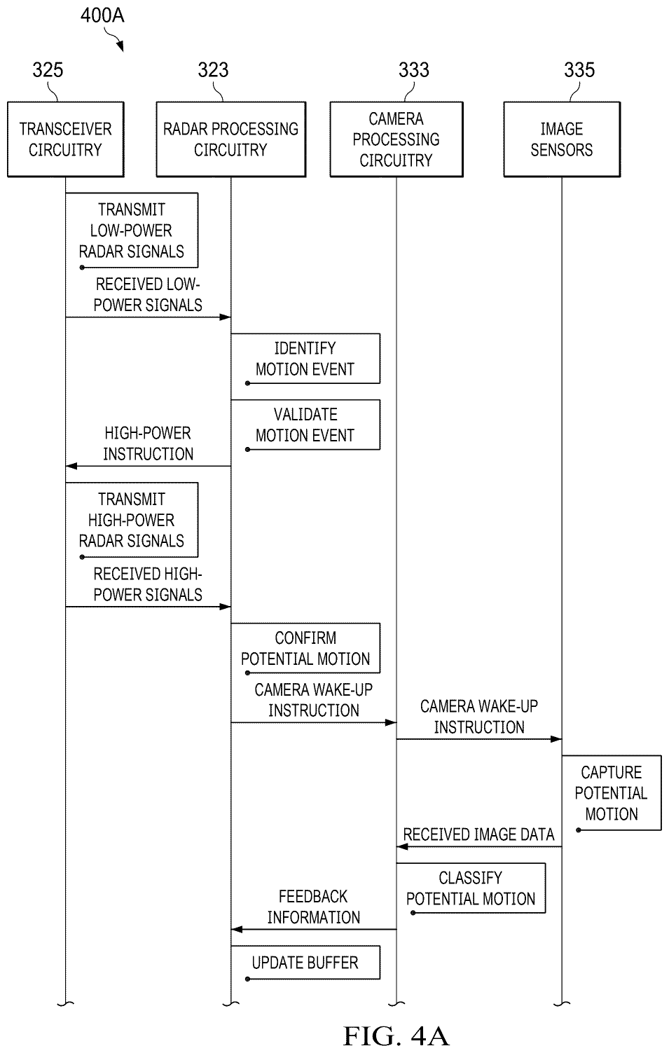

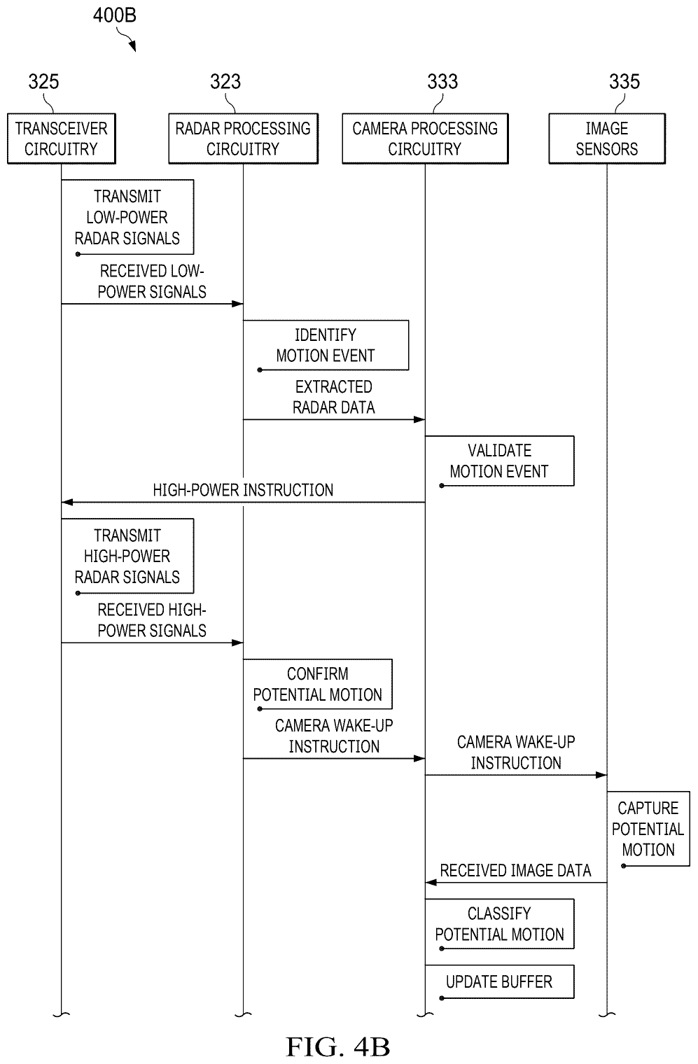

Memory 331 is representative of one or more volatile or non-volatile computer-readable storage media including instructions, data, and the like. For example, memory 331 may be representative of SRAM, DRAM, flash memory, or another memory of the like configured to store the data for camera subsystem 329. In an implementation, memory 331 includes feedback information buffer 322. For example, rather than being stored in memory 321, feedback information buffer 322 may instead be stored within memory 331. During operation, camera processing circuitry 333 may retrieve data from feedback information buffer 322 to determine if a potential motion event is a false alarm event, later discussed in detail with reference to FIG. 4B.

Camera processing circuitry 333 is representative of one or more processing units configured to execute program instructions. For example, camera processing circuitry 333 may be representative of a CPU, MCU, ASIC, DSP, graphics processing unit (GPU), tensor processing unit (TPU), or another processing unit of like configured to execute program code. In an implementation, camera processing circuitry 333 is configured to determine if a motion event detected by radar subsystem 319 is a human motion event (i.e., actual motion event) or a non-human motion event (i.e., false alarm event). For example, when instructed to transition to the awake mode, camera processing circuitry 333 is configured to instruct image sensors 335 to begin collecting image data of scene 301 and provide the collected data to camera processing circuitry 333. In response, camera processing circuitry 333 processes the collected image data to determine if the image data depicts a human or non-human motion event. For example, camera processing circuitry 333 may be configured to execute convolutional neural networks (CNNs), YOLO models, or another image processing algorithm of the like with respect to the image data collected by image sensors 335.

In an implementation, if camera processing circuitry 333 determines that the image data collected by image sensors 335 depicts a non-human motion event, then camera processing circuitry 333 is configured to provide data of the non-human motion event to feedback information buffer 322. For example, if the non-human motion event includes a tree branch swaying in the wind, then camera processing circuitry 333 may label the motion event as “tree branch movement” and provide the label to feedback information buffer 322. Alternatively, if camera processing circuitry 333 determines that the image data collected by image sensors 335 depicts a human motion event, then camera processing circuitry 333 is configured to warn an associated user of the human motion event. For example, camera processing circuitry 333 may instruct host processing circuitry 317 to stream the image data collected by image sensors 335 to end-user device 311. Alternatively, camera processing circuitry 333 may instruct host processing circuitry 317 to provide a warning to end-user device 311, such that the warning indicates the detected human motion event.

Image sensors 335 are representative of a collection of sensors (e.g., cameras) that are configured to collect image or video data of an environment. For example, image sensors 335 may be configured to capture an image of, or a recording of, the movement which is occurring within scene 301. In an implementation, image sensors provide collected data to camera processing circuitry 333 for processing.

Now turning to the next figures, FIGS. 4A and 4B respectively illustrate operational sequence 400A and operational sequence 400B in an implementation. Operational sequences 400A and 400B are representative of example sequences for detecting motion with respect to the elements of FIGS. 3A and 3B. More specifically, operational sequence 400A is representative of a sequence for when feedback information buffer 322 is stored within memory 321, while operational sequence 400B is representative of a sequence for when feedback information buffer 322 is stored within memory 331. Operational sequences 400A and 400B include transceiver circuitry 325, radar processing circuitry 323, camera processing circuitry 333, and image sensors 335.

To begin operational sequence 400A, transceiver circuitry 325 starts in the low-power mode and transmits low-power radar signals across scene 301. For example, transceiver circuitry 325 may transmit radar signal 327 across scene 301, such that radar signal 327 is a low-power energy signal. Next, transceiver circuitry 325 receives a low-power radar signal (in response to the transmitted radar signal) and provides the received low-power radar signal to radar processing circuitry 323.

Once received, radar processing circuitry 323 is configured to analyze the data of the received low-power radar signal to determine if a motion event occurred within scene 301. If radar processing circuitry 323 determines that no motion event occurred, then radar processing circuitry 323 instructs transceiver circuitry 325 to continue to operate under the low-power mode. Alternatively, if radar processing circuitry 323 determines that a motion event occurred, then radar processing circuitry 323 is configured to extract data related to the motion event from the received low-power radar signal. For example, radar processing circuitry 323 may extract a 3D real-world location of the potential motion event and an SNR of the potential motion event from the received low-power radar signal.

Next, after identifying the motion event within scene 301, radar processing circuitry 323 is configured to validate the motion event to determine if the motion event is a non-human motion event or a potential human motion event. In an implementation, to validate the potential motion event, radar processing circuitry 323 is configured to perform a comparison operation between the data of the motion event and the data stored by feedback information buffer 323, which information is representative of previously detected non-human motion events. For example, radar processing circuitry 323 may perform a comparison between a 3D real-world location of the motion event and the 3D real-world locations of the previously detected non-human motion events. In another example, radar processing circuitry 323 may perform a second comparison between the SNR of the motion event and the SNRs of the previously detected non-human motion events.

In an implementation, if radar processing circuitry 323 determines that the data of the motion event matches data stored by feedback information buffer 322, then radar processing circuitry 323 classifies the motion event as a non-human motion event and instructs transceiver circuitry 325 to continue to operate in the low-power mode. Alternatively, if radar processing circuitry 323 determines that the data of the motion event does not match any of the data stored by feedback information buffer 322, then radar processing circuitry 323 classifies the motion event as a potential human motion event and instructs transceiver circuitry 325 to transition to the high-power mode.

Next, after radar processing circuitry 325 instructs transceiver circuitry 325 to transition to the high-power mode, transceiver circuitry 325 begins transmitting high-power radar signals across scene 301. For example, transceiver circuitry 325 may transmit radar signal 327 across scene 301, such that radar signal 327 is a high-power energy signal. Next, transceiver circuitry 325 receives a high-power radar signal (in response to the transmitted radar signal) and provides the received high-power radar signal to radar processing circuitry 323.

Once received, radar processing circuitry 323 is configured to analyze the data of the received high-power radar signal to confirm whether or not the detected motion event that occurred within scene 301 and initially classified as a potential human motion event based on analysis of the low-power radar signals is a potential human event. If radar processing circuitry 323 is unable to confirm that the initial potential human motion event classification based on the received high-power radar signal, then radar processing circuitry 323 is configured to instruct transceiver circuitry 325 to return to operating under the low-power mode. Alternatively, if radar processing circuitry 323 is able to confirm the detected motion event as a potential human motion event based on the received high-power radar signal, then radar processing circuitry 323 is configured to instruct camera subsystem 329 to transition from the sleep state to the awake state. For example, radar processing circuitry 323 may send a wake-up instruction to camera processing circuitry 333, and in response, camera processing circuitry 333 instructs image sensors 335 to begin collecting image data of scene 301.

Next, image sensors 335 begin collecting image data of scene 301 and provide the collected image data to camera processing circuitry 333. In response, camera processing circuitry 333 is configured to process the collected image data to determine if the detected motion event, currently classified by radar processing circuitry 323 as a potential human motion event, is an actual human motion event, or a new non-human motion event, i.e., a false alarm event not previously confirmed. For example, camera processing circuitry 333 may execute a CNN with respect to the collected image data.

In an implementation, if camera processing circuitry 333 determines that the potential human motion event is an actual human motion event, then camera processing circuitry 333 is configured to stream the collected image data to end-user device 311 via host processing circuitry 317. Alternatively, if camera processing circuitry 333 determines that the potential human motion event is a new non-human motion event, then camera processing circuitry 333 is configured to provide feedback information of the new non-human motion event to radar processing circuitry 323. For example, if the new non-human motion event depicts a bird flying through scene 301, then camera processing circuitry 333 may label the new non-human motion event as “bird” and provide the label as feedback information to radar processing circuitry 323. Alternatively, if the new non-human motion event depicts a street sign swaying in the wind, then camera processing circuitry 333 may label the new non-human motion event as “sign” and provide the label as feedback information to radar processing circuitry 323.

In response, radar processing circuitry 323 determines to update feedback information buffer 322 to include the feedback information of the new non-human motion event, such as the label for the new non-human motion event, the 3D real-world location for the new non-human motion event, and the SNR for the new non-human motion event. In an implementation, to determine to update feedback information buffer 322, radar processing circuitry 323 is configured to analyze the feedback information of the new non-human motion event to determine if the new non-human motion event represents a stationary motion event or a non-stationary motion event. A stationary motion event depicts a non-human motion of a stationary object (e.g., tree, street sign, etc.), while a non-stationary motion event depicts a non-human motion of a non-stationary object (e.g., animal). In an implementation, if radar processing circuitry 323 determines that the new non-human motion event is a stationary motion event, then radar processing circuitry 323 may determine to update feedback information buffer 322 to include the feedback information of the new non-human motion event. Alternatively, if radar processing circuitry 323 determines that the new non-human motion event is a non-stationary motion event, then radar processing circuitry 323 may delete the feedback information of the new non-human motion event from host device 315. In either case, after determining whether to update feedback information buffer 322, radar processing circuitry 323 is configured to instruct camera subsystem 329 to transition back to the sleep mode and instruct transceiver circuitry 325 to transition back to the low-power mode.

In an implementation, in addition to the feedback information, camera processing circuitry 333 is also configured to provide battery power feedback to radar processing circuitry 323. The battery power feedback describes feedback which indicates the current battery life of host device 315. For example, the battery power feedback may indicate that the current battery percentage of host device 315 has reached a critical point. In an implementation, if the battery power feedback indicates that host device 315 has reached the critical point, then radar processing circuitry 323 is configured to transition radar subsystem 319 from the low-power mode to the lowest-power mode. The lowest-power mode describes an operative mode where transceiver circuitry 325 transmits and receives lower-power energy radar signals. For example, if radar subsystem 319 is capable of detecting motion that is ten feet away when in the low-power mode, then radar subsystem 319 may be capable of detecting motion that is three feet away when in the lowest-power mode.

Now turning to FIG. 4B, operational sequence 400B illustrates a variation of operational sequence 400A, where feedback information buffer 322 is stored within memory 331 instead of being stored within memory 321. Advantageously, camera subsystem 329 includes a larger memory than radar subsystem 319, and as a result, when stored in memory 331, feedback information buffer 322 may store more data, as compared to being stored in memory 321.

To begin, transceiver circuitry 325 starts in the low-power mode and transmits low-power radar signals (e.g., radar signal 127) across scene 301. Next, in response to the transmitted low-power radar signals, transceiver circuitry 325 receives a low-power radar signal and provides the received low-power radar signal to radar processing circuitry 323. Once received, radar processing circuitry 323 analyzes the data of the received low-power radar signal to determine if a motion event occurred within scene 301.

If radar processing circuitry 323 determines that no motion event occurred, then radar processing circuitry 323 instructs transceiver circuitry to continue to operate under the low-power mode. Alternatively, if radar processing circuitry 323 determines that a motion event occurred, then radar processing circuitry 323 is configured to extract data related to the motion event from the received low-power radar signal. For example, radar processing circuitry 323 may extract a 3D real-world location of the motion event and an SNR of the motion event from the received low-power radar signal.

Next, radar processing circuitry 323 is configured to provide the extracted radar data to camera processing circuitry 333, and in response, camera processing circuitry 333 is configured to validate the motion event to determine if the motion event represents a non-human motion event or a potential human motion event. In an implementation, to validate the motion event, camera processing circuitry 333 is configured to perform a comparison operation between the data of the motion event and the data stored by feedback information buffer 322. For example, camera processing circuitry 333 may compare a 3D real-world location of the motion event to the 3D real-world locations of the previously detected non-human motion events. In another example, camera processing circuitry 333 may also compare the SNR of the motion event to the SNRs of the previously detected non-human motion events.

In an implementation, if camera processing circuitry 333 determines that the data of the motion event matches data stored by feedback information buffer 322, then camera processing circuitry 333 classifies the motion event as a non-human motion event and instructs transceiver circuitry 325 to continue to operate in the low-power mode. Alternatively, if camera processing circuitry 333 determines that the data of the motion event does not match any of the data stored by feedback information buffer 322, then camera processing circuitry 333 classifies the motion event as a potential human motion event and instructs transceiver circuitry 325 to transition to the high-power mode.

Once instructed to enter the high-power mode, transceiver circuitry 325 begins transmitting high-power radar signals (e.g., radar signal 327) across scene 301, and in response receives a high-power radar signal which is provided to radar processing circuitry 323. Radar processing circuitry 323 analyzes the data of the received high-power radar signal to confirm the low-power radar signal classification of the detected motion event as a potential human motion event. If radar processing circuitry 323 is unable to confirm that the detected motion event is a potential human motion event based on the received high-power radar signal, then radar processing circuitry 323 is configured to instruct transceiver circuitry 325 to return to operating under the low-power mode. Alternatively, if radar processing circuitry 323 is able to confirm the initial classification of the detected motion event as a potential human motion event based on the received high-power radar signal, then radar processing circuitry 323 is configured to instruct camera subsystem 329 to transition from the sleep state to the awake state. For example, radar processing circuitry 323 may send a wake-up instruction to camera processing circuitry 333, and in response, camera processing circuitry 333 instructs image sensors 335 to begin capturing image data of scene 301.

Next, image sensors 335 begin collecting image data of scene 301 and provide the collected image data to camera processing circuitry 333. In response, camera processing circuitry 333 processes the collected image data to determine if the potential human motion event is an actual human motion event, or a new non-human motion event. For example, camera processing circuitry 333 may execute a CNN with respect to the collected image data.

In an implementation, if camera processing circuitry 333 determines that the potential human motion event is an actual human motion event, then camera processing circuitry 333 is configured to stream the collected image data to end-user device 311 via host processing circuitry 317. Alternatively, if camera processing circuitry 333 determines that the potential human motion event is a new non-human motion event, then camera processing circuitry 333 is configured to determine to store feedback information related to the new non-human motion event within feedback information buffer 322, such as the label for the new non-human motion event, the 3D real-world location for the new non-human motion event, and the SNR for the new non-human motion event.

In an implementation, to determine to update feedback information buffer 322, camera processing circuitry 333 is configured to analyze the feedback information of the new non-human motion event to determine if the new non-human motion event represents a stationary motion event or a non-stationary motion event. If camera processing circuitry 333 determines that the new non-human motion event is a stationary motion event, then camera processing circuitry 333 may determine to update feedback information buffer 322 to include the feedback information of the new non-human motion event. Alternatively, if camera processing circuitry 333 determines that the new non-human motion event is a non-stationary motion event, then camera processing circuitry 333 may delete the feedback information of the new non-human motion event from host device 315. In either case, after determining whether to update feedback information buffer 322, camera processing circuitry 333 is configured to instruct transceiver circuitry 325 to transition back to the low-power mode, and instruct camera subsystem 329 to transition back to the sleep mode.

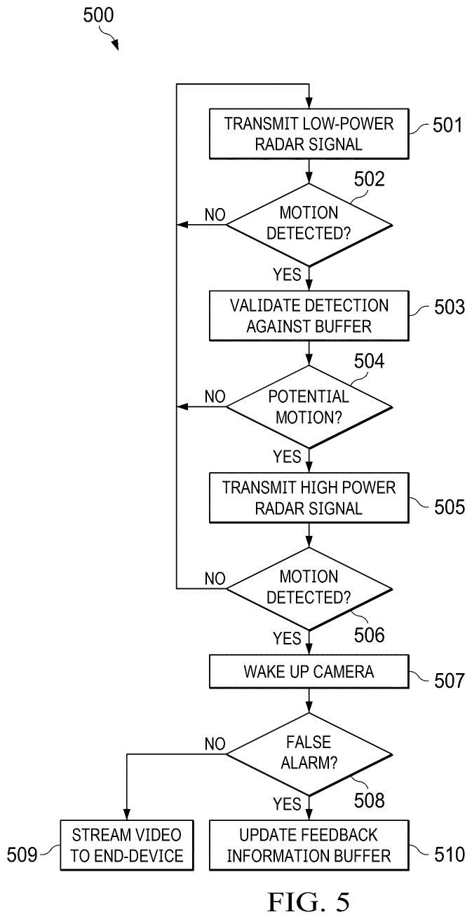

FIG. 5 illustrates detection process 500 in an implementation. Detection process 500 is representative of another process for detecting motion within an environment. For example, detection process 500 may represent detection method 200 of FIG. 2. Detection process 500 may be implemented in the context of program instructions that, when executed by a suitable computing system, direct the processing circuitry of the computing system to operate as follows, referring parenthetically to the steps in FIG. 5. For the purposes of explanation, detection process 500 will be explained as a process for detecting human motion with respect to the elements of FIGS. 3A and 3B. This specification is not meant to limit the applications of detection process 500, but rather to provide an example.

To begin, transceiver circuitry 325 starts in the low-power mode and transmits low-power radar signals across scene 301 (step 501). For example, transceiver circuitry 325 may transmit radar signal 327 across scene 301, such that radar signal 327 is a low-power energy signal. Next, transceiver circuitry 325 provides the received low-power radar signals to radar processing circuitry 323, and in response, radar processing circuitry 323 analyzes the data of the received low-power radar signals to determine if a motion event occurred within scene 301 (step 502).

If radar processing circuitry 323 determines that no motion event occurred based on the received low-power radar signals, then radar processing circuitry 323 is configured to instruct transceiver circuitry 325 to continue operating in the low-power mode (step 501). Alternatively, if radar processing circuitry 323 determines that a motion event occurred, and feedback information buffer 322 is stored within memory 321, then radar processing circuitry 323 is configured to perform a comparison operation between the data of the motion event and the data stored by feedback information buffer 322 to determine if the motion event is a potential human motion event (step 503).

For example, to perform the comparison operation, radar processing circuitry 323 may first be configured to extract data from the received low-power radar signal, such as a 3D real-world location of the motion event and an SNR of the motion event. Once extracted, radar processing circuitry 323 is then configured to compare the extracted data to the data stored by feedback information buffer 322 to determine if the motion event is a potential human motion event or matches a previously detected non-human motion event (step 504). For example, radar processing circuitry 323 may compare the 3D real-world location of the motion event with the 3D real-world locations stored by feedback information buffer 322. In addition, radar processing circuitry 323 may also compare the SNR of the motion event with the SNRs stored by feedback information buffer 322.

In an implementation, if radar processing circuitry 323 determines that the data of the motion event matches data stored by feedback information buffer 322, then radar processing circuitry 323 classifies the motion event as a non-human motion event, and in response, instructs transceiver circuitry 325 to continue to operate in the low-power mode (step 501). Alternatively, if radar processing circuitry 323 determines that the data of the motion event does not match any of the data stored by feedback information buffer 322, then radar processing circuitry 323 classifies the motion event as a potential human motion event and instructs transceiver circuitry 325 to transition to the high-power mode. In response, transceiver circuitry 325 begins transmitting high-power radar signals across scene 301 (step 505).

For example, transceiver circuitry 325 may transmit radar signal 327 across scene 301, such that radar signal 327 is a high-power energy signal. Next, transceiver circuitry 325 provides the received high-power radar signals to radar processing circuitry 323, and in response, radar processing circuitry 323 analyzes the data of the received high-power radar signals to confirm the initial classification of the detected motion event within scene 301 as a potential human motion event (step 506). If radar processing circuitry 323 is unable to confirm that the detected motion event is a potential human motion event based on the received high-power radar signals, then radar processing circuitry 323 instructs transceiver circuitry 325 to transition back to the low-power mode (step 501).

Alternatively, if radar processing circuitry 323 is able to confirm the potential human motion event based on the received high-power radar signals, then radar processing circuitry 323 is configured to instruct camera subsystem 329 to transition from the sleep state to the awake state (step 507). For example, radar processing circuitry 323 may send a wake-up instruction to camera processing circuitry 333, and in response, camera processing circuitry 333 instructs image sensors 335 to begin collecting image data of scene 301 and provide the collected image data to camera processing circuitry 333. Once received, camera processing circuitry 333 executes an image processing algorithm (e.g., CNN, YOLO) on the collected image data to determine if the potential human motion event is an actual human motion event or a new non-human motion event (step 508).

If camera processing circuitry 333 determines that the potential human motion event is an actual human motion event, then camera processing circuitry 333 is configured to stream the collected image data to end-user device 311 via host processing circuitry 317 (step 509). Alternatively, if camera processing circuitry 333 determines that the potential human motion event is a new non-human motion event, then camera processing circuitry 333 is configured to provide feedback information of the new non-human motion event to radar processing circuitry 323.

For example, if the new non-human motion event depicts a dog walking through scene 301, then camera processing circuitry 333 may label the new non-human motion event as “dog” and provide the label of the new non-human motion event to radar processing circuitry 323. In response, radar processing circuitry 323 may determine to update feedback information buffer 322 to include the label of the new non-human motion event, the 3D real-world location of the new non-human motion event, and the SNR of the new non-human motion event (step 510). In an implementation, to determine to update feedback information buffer 322, radar processing circuitry 323 is configured to analyze the feedback information of the new non-human motion event to determine if the new non-human motion event represents a stationary motion event or a non-stationary motion event. For example, radar processing circuitry 323 may analyze the label of the new non-human motion event, the height of the non-new human motion event, or other attributes of the like to determine if the new non-human motion event depicts a stationary motion event or a non-stationary motion event.

If radar processing circuitry 323 determines that the new non-human motion event is a stationary motion event, then radar processing circuitry 323 may determine to update feedback information buffer 322 to include the feedback information of the new non-human motion event. Alternatively, if radar processing circuitry 323 determines that the new non-human motion event is a non-stationary motion event, then radar processing circuitry 323 may delete the feedback information of the new non-human motion event from host device 315. In either case, after determining whether to update feedback information buffer 322, radar processing circuitry 323 is configured to instruct camera subsystem 329 to transition back to the sleep mode and instruct transceiver circuitry 325 to transition back to the low-power mode.

Returning to step 502, in another implementation, if radar processing circuitry 323 determines that a motion event occurred, and feedback information buffer 322 is instead stored within memory 331, then radar processing circuitry 323 is configured to extract data related to the motion event from the received low-power radar signal and provide the extracted data to camera processing circuitry 333. For example, radar processing circuitry 323 may extract a 3D real-world location of the motion event and an SNR of the motion event from the received low-power radar signal and provide the extracted data to camera processing circuitry 333.

In response, camera processing circuitry 333 validates the motion event to determine if the motion event represents a non-human motion event or a potential human motion event (step 503). For example, camera processing circuitry 333 may perform a comparison operation between the data of the motion event and the data stored by feedback information buffer 323, which contains information about previously detected non-human motion events. If camera processing circuitry 333 determines that the data of the motion event matches data stored by feedback information buffer 322, then camera processing circuitry 333 classifies the motion event as a non-human motion event and instructs transceiver circuitry 325 to continue to operate in the low-power mode (step 501). Alternatively, if camera processing circuitry 333 determines that the data of the potential motion event does not match any of the data stored by feedback information buffer 322, then camera processing circuitry 333 classifies the motion event as a potential human motion event (step 504) and instructs transceiver circuitry 324 to transition to the high-power mode. In response, transceiver circuitry 325 begins transmitting high-power radar signals across scene 301 (step 505).

For example, transceiver circuitry 325 may transmit radar signal 327 across scene 301, such that radar signal 327 is a high-power energy signal. Next, transceiver circuitry 325 provides the received high-power radar signals to radar processing circuitry 323, and in response, radar processing circuitry 323 analyzes the data of the received high-power radar signals to confirm the initial classification of the detected motion event within scene 301 as a potential human motion event (step 506). If radar processing circuitry 323 is unable to confirm that initial classification based on the received high-power radar signals, then radar processing circuitry 323 instructs transceiver circuitry 325 to transition back to the low-power mode (step 501).

Alternatively, if radar processing circuitry 323 is able to confirm the classification of the detected motion event as a potential human motion event based on the received high-power radar signals, then radar processing circuitry 323 is configured to instruct camera subsystem 329 to transition from the sleep state to the awake state (step 507). For example, radar processing circuitry 323 may send a wake-up instruction to camera processing circuitry 333, and in response, camera processing circuitry 333 instructs image sensors 335 to begin collecting image data of scene 301 and provide the collected image data to camera processing circuitry 333. Once received, camera processing circuitry 333 executes an image processing algorithm (e.g., CNN) on the collected image data to determine if the potential human motion event is an actual human motion event or a new non-human motion event (step 508).

If camera processing circuitry 333 determines that the potential human motion event is an actual human motion event, then camera processing circuitry 333 is configured to stream the collected image data to end-user device 311 via host processing circuitry 317 (step 509). Alternatively, if camera processing circuitry 333 determines that the potential human motion event is a new non-human motion event, then camera processing circuitry 333 is configured to determine to store the label of the new non-human motion event, the 3D real-world location of the new non-human motion event, and the SNR of the new non-human motion event within feedback information buffer 322 (step 510).

In an implementation, to determine to update feedback information buffer 322, camera processing circuitry 333 is configured to analyze the feedback information of the new non-human motion event to determine if the new non-human motion event represents a stationary motion event or a non-stationary motion event. If camera processing circuitry 333 determines that the new non-human motion event is a stationary motion event, then camera processing circuitry 333 may determine to update feedback information buffer 322 to include the feedback information of the new non-human motion event. Alternatively, if camera processing circuitry 333 determines that the new non-human motion event is a non-stationary motion event, then camera processing circuitry 333 may delete the feedback information of the new non-human motion event from host device 315. In either case, after determining whether to update feedback information buffer 322, camera processing circuitry 333 is configured to instruct camera subsystem 329 to transition back to the sleep mode and instruct transceiver circuitry 325 to transition back to the low-power mode.

Returning back to step 502, in another implementation, if radar processing circuitry 323 determines that a motion event occurred based on a received low-power radar signal, and feedback information buffer 322 is stored within memory 321, then radar processing circuitry 323 may instead be configured to instruct transceiver circuitry 325 to immediately transition to the high-power mode (step 505). Once instructed, transceiver circuitry 325 begins providing received high-power radar signals to radar processing circuitry 323, and in response, radar processing circuitry 323 confirms if the motion event occurred based on the received high-power radar signals. In an implementation, if radar processing circuitry 323 is unable to confirm that the motion event occurred, then radar processing circuitry 323 instructs transceiver circuitry 325 to return to operating under the low-power mode. Alternatively, if radar processing circuitry 323 is able to confirm that the motion event occurred, then radar processing circuitry 323 is configured to perform a comparison operation between the data of the motion event and the data stored by feedback information buffer 322 to determine if the motion event is a potential human motion event (step 503).

For example, to perform the comparison operation, radar processing circuitry 323 may first be configured to extract data from the received high-power radar signal, such as a 3D real-world location of the motion event and an SNR of the motion event. Once extracted, radar processing circuitry 323 is then configured to compare the extracted data to the data stored by feedback information buffer 322 to determine if the motion event is a potential human motion event or a non-human motion event (step 504). For example, radar processing circuitry 323 may compare the 3D real-world location of the motion event with the 3D real-world locations stored by feedback information buffer 322, which contains information about previously detected non-human motion events. In addition, radar processing circuitry 323 may also compare the SNR of the motion event with the SNRs stored by feedback information buffer 322.

In an implementation, if radar processing circuitry 323 determines that the data of the motion event matches data stored by feedback information buffer 322, then radar processing circuitry 323 classifies the motion event as a non-human motion event, and in response, instructs transceiver circuitry 325 to return to the low-power mode (step 501). Alternatively, if radar processing circuitry 323 determines that the data of the motion event does not match any of the data stored by feedback information buffer 322, then radar processing circuitry 323 classifies the motion event as a potential human motion event and instructs camera subsystem 329 to transition from the sleep state to the awake state (step 507). For example, radar processing circuitry 323 may send a wake-up instruction to camera processing circuitry 333, and in response, camera processing circuitry 333 instructs image sensors 335 to begin collecting image data of scene 301 and provide the collected image data to camera processing circuitry 333. Once received, camera processing circuitry 333 executes an image processing algorithm on the collected image data to determine if the potential human motion event is an actual human motion event or a new non-human motion event (step 508).

If camera processing circuitry 333 determines that the potential human motion event is an actual human motion event, then camera processing circuitry 333 is configured to stream the collected image data to end-user device 311 via host processing circuitry 317 (step 509). Alternatively, if camera processing circuitry 333 determines that the potential human motion event is a new non-human motion event, then camera processing circuitry 333 is configured to provide a label of the new non-human motion event as feedback information to radar processing circuitry 323. In response, radar processing circuitry 323 may determine to update feedback information buffer 322 to include the feedback information of the new non-human motion event (step 510).

In an implementation, to determine to update feedback information buffer 322, radar processing circuitry 323 is configured to analyze the feedback information of the new non-human motion event to determine if the new non-human motion event represents a stationary motion event or a non-stationary motion event. If radar processing circuitry 323 determines that the new non-human motion event is a stationary motion event, then radar processing circuitry 323 may determine to update feedback information buffer 322 to include the label, the 3D real-world coordinates, and the SNR of the new non-human motion event. Alternatively, if radar processing circuitry 323 determines that the new non-human motion event is a non-stationary motion event, then radar processing circuitry 323 may delete the feedback information of the new non-human motion event from host device 315. In either case, after determining whether to update feedback information buffer 322, radar processing circuitry 323 is configured to instruct camera subsystem 329 to transition back to the sleep mode and instruct transceiver circuitry 325 to transition back to the low-power mode.

Advantageously, detection process 500 provides a method for detecting motion of interest within an environment which mitigates the number of times the camera is awoken. As a result, detection process 500 provides a technique for detecting motion of interest within an environment which preserves the processing resources, and in turn, the battery life of the associated system.

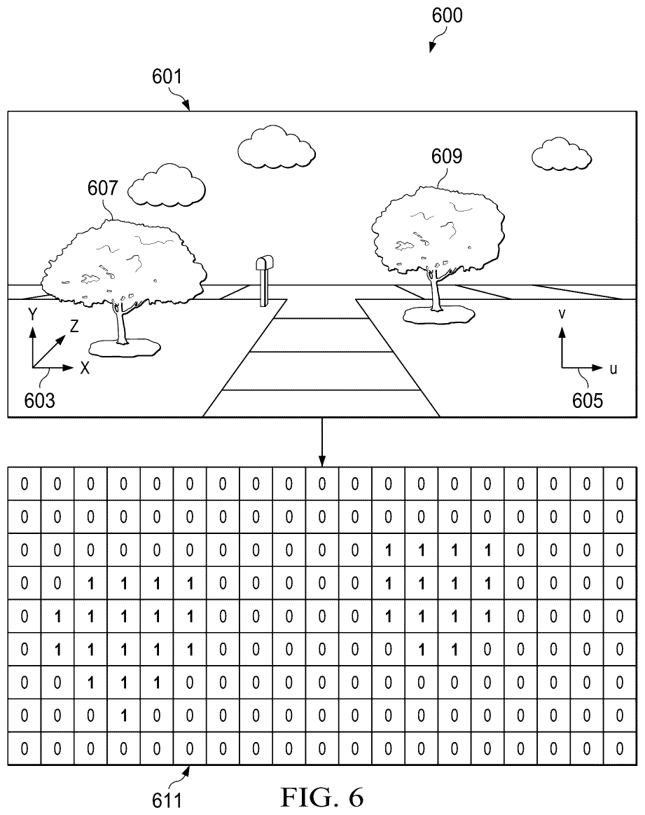

Now turning to the next figure, FIG. 6 illustrates detection scenario 600 in an implementation. Detection scenario 600 depicts a scenario for determining if a motion event within a scene is a potential motion event or a false alarm event. For example, detection scenario 600 may demonstrate a scenario for performing detection method 200 or detection process 500. Detection scenario 600 includes scene 601 and grid 611.

Scene 601 is representative of an environment in which a user desires surveillance and to detect motion of interest, e.g., human motion. For example, scene 601 may be similar to 3D scene 121 or scene 301. In an implementation, scene 601 represents the image which is displayed to an end-user device. For example, when a video doorbell (e.g. host device 315) detects human motion within scene 601, the video doorbell is configured to stream scene 601 to an end-user device (e.g., end-user device 311). Scene 601 includes 3D coordinate axis 603, 2D coordinate axis 605, tree 607, and tree 609.

3D coordinate axis 603 is representative of an axis which describes the 3D real-world coordinates depicted in scene 601 (i.e., (X,Y,Z)). For example, 3D coordinate axis 603 may be representative of 3D coordinate axis 303 of FIG. 3. In an implementation, the radar subsystem of an associated video doorbell (e.g., radar subsystem 319) is configured to utilize 3D coordinate axis 603 to identify the 3D real-world coordinates of various radar reflections. For example, the radar subsystem may utilize 3D coordinate axis 603 to determine the 3D real-world location of a detected motion event. In an implementation, the radar subsystem of a video doorbell utilizes 3D coordinate axis 603 to generate feedback information related to the detection of false alarm events. For example, if the video doorbell is configured to detect human motion, and the video doorbell determines that a detected motion event represents tree 607 swaying in the wind, then the radar subsystem of the video doorbell is configured to utilize 3D coordinate axis 603 to determine the location of the non-human motion event, and store the location within an associated false alarm buffer (e.g., feedback information buffer 322).

2D coordinate axis 605 is representative of an axis which describes the 2D image coordinates depicted in scene 601 (i.e., (u,v)). For example, 2D coordinate axis 605 may be representative of 2D coordinate axis 305 of FIG. 3. In an implementation, the camera subsystem of an associated video doorbell (e.g., camera subsystem 329) is configured to utilize 2D coordinate axis 605 to identify the 2D image coordinates of various detected movements. For example, the camera subsystem may utilize 2D coordinate axis 605 to identify the 2D image location of a detected motion event (e.g., tree 607 swaying in the wind).

Trees 607 and 609 represent objects within the environment depicted by scene 601. As such, trees 607 and 609 are representative of exemplary objects, and may instead depict a street sign, a person, an animal, or another object of the like, but for the purposes of explanation, trees will be discussed herein.

In an implementation, a video doorbell associated with scene 601 is configured to determine if a newly detected motion event is a potential motion event or a false alarm event based on the data of grid 611. Grid 611 is representative of a 2D grid which depicts a top-down view of scene 601. Meaning that, grid 611 provides a grid representation for the (X,Z) coordinates depicted in scene 601, such that each cell within grid 611 represents a certain area (e.g., 1 meter×1 meter cell). In an implementation, a video doorbell associated with scene 601 is configured to populate grid 611 with the data of previously detected false alarm events. For example, if the video doorbell is configured to detect human motion, and the video doorbell determines that a detected motion event depicts tree 609 swaying in the wind, then the video doorbell is configured to populate the cells of grid 611 which correspond to the (X,Z) coordinates of tree 609 with ones and populate the remaining cells of grid 611 with zeros. In an implementation, grid 611 is stored within the memory of the video doorbell. For example, within the context of FIG. 3, grid 611 may be stored within feedback information buffer 322.

In an implementation, the video doorbell that is associated with scene 601 is further configured to create false detection zones within grid 611. A false detection zone (i.e., region of non-interest) describes a section within scene 601 in which the user does not desire surveillance. For example, a user may indicate to the video doorbell that they do not wish to be notified when movement is detected around trees 607 and 609, and in response, the video doorbell may populate the cells of grid 611 which correspond to the (X,Z) coordinates of trees 607 and 609 with ones and populate the remaining cells of grid 611 with zeros. In an implementation, the video doorbell that is associated with scene 601 is further configured to remove data from grid 611 after a certain period of time. For example, after populating a cell of grid 611 with a one, the video doorbell may wait a duration of time (e.g., ten minutes), and if no motion events are detected at the cell location within said duration, then the video doorbell may store a zero at the cell location. To implement this, for each cell in the grid, in addition to its state (one/zero), the buffer would also have to store the most recent time at which the cell was set to one.

In a brief operational scenario, to determine if a newly detected motion event is a potential motion event or a false alarm event, the radar subsystem of the video doorbell is first configured to transmit and receive radar signals across scene 601. Next, the radar subsystem is configured to process the received radar signals to determine if a motion event occurred within scene 601. If the radar subsystem determines that a motion event occurred, then the radar subsystem is configured to extract data from the received radar signal to determine if the motion event is a potential motion event or a previously detected false alarm event. For example, the radar subsystem may extract the (X,Z) coordinates of the motion event from the received radar signal. Once extracted, the radar subsystem is configured to compare the (X,Z) coordinates of the motion event to the data stored in grid 611.

If the radar subsystem determines that the (X,Z) coordinates of the motion event does not match the false alarm data represented within grid 611 then the radar subsystem is configured to confirm the motion event as a potential motion event. Alternatively, if the radar subsystem determines that the (X,Z) coordinates of the motion event does match the false alarm data represented within grid 611 then the radar subsystem is configured to confirm the motion event corresponds to a previously detected false alarm event. In an implementation, if the radar subsystem confirms the motion event as a potential motion event, then the radar subsystem is configured to wake up an associated camera subsystem to cause the associated camera subsystem to determine if the potential motion event is an actual motion event or a new false alarm event. For example, if the video doorbell is configured to detect human motions, then the camera subsystem is configured to determine if the potential motion event is an actual human motion event or a new non-human motion event.

In an implementation, if the camera subsystem determines that the potential motion event is a new false alarm event, then the camera subsystem is configured to provide feedback information related to the new false alarm event to the radar subsystem. For example, the camera subsystem may provide a label of the new false alarm event to the radar subsystem. In response, the radar subsystem may update grid 611 with the label of the new false alarm event and the (X,Z) coordinates of the new false alarm event.

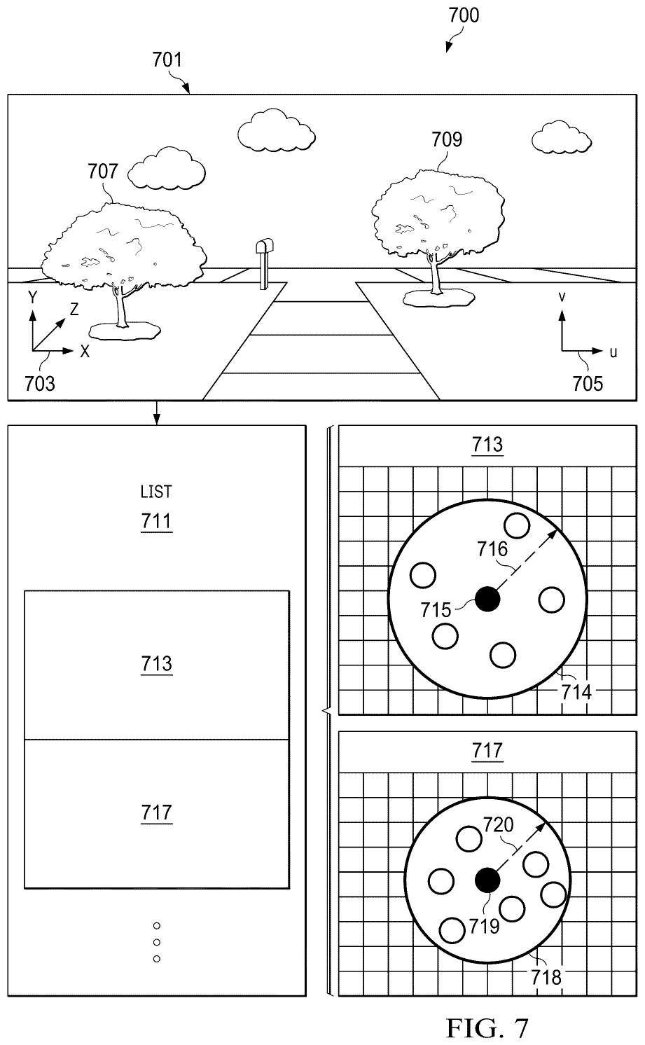

FIG. 7 illustrates detection scenario 700 in an implementation. Detection scenario 700 depicts another scenario for determining if a motion event within a scene is a potential motion event or corresponds to a previously detected false alarm event. For example, detection scenario 700 may demonstrate another scenario for performing detection method 200 or detection process 500. Detection scenario 700 includes scene 701 and list 711.

Scene 701 is representative of an environment in which a user desires surveillance and to detect motion of interest, e.g., human motion. For example, scene 701 may depict 3D scene 121, scene 301, or scene 601. In an implementation, scene 701 represents the image which is displayed to an end-user device. For example, when a video doorbell (e.g. host device 315) detects human motion within scene 701, the video doorbell is configured to stream scene 701 to an end-user device (e.g., end-user device 311). Scene 701 includes 3D coordinate axis 703, 2D coordinate axis 705, tree 707, and tree 709.

3D coordinate axis 703 is representative of an axis which describes the 3D real-world coordinates depicted in scene 701 (i.e., (X,Y,Z)). For example, 3D coordinate axis 703 may be representative of 3D coordinate axis 303 or 3D coordinate axis 603. In an implementation, the radar subsystem of an associated video doorbell (e.g., radar subsystem 319) is configured to utilize 3D coordinate axis 703 to identify the 3D real-world coordinates of various radar reflections. For example, the radar subsystem may utilize 3D coordinate axis 703 to determine the 3D real-world location of a detected motion event.

In an implementation, the radar subsystem of a video doorbell utilizes 3D coordinate axis 703 to generate feedback information related to the detection of false alarm events. For example, if the video doorbell is configured to detect human motion, and the video doorbell determines that a detected motion event is tree 707 swaying in the wind, then the radar subsystem of the video doorbell is configured to utilize 3D coordinate axis 703 to determine the location of the non-human motion event, and store the location within an associated false alarm buffer (e.g., feedback information buffer 322).

2D coordinate axis 705 is representative of an axis which describes the 2D image coordinates depicted in scene 701 (i.e., (u,v)). For example, 2D coordinate axis 705 may include 2D coordinate axis 305 or 2D coordinate axis 605. In an implementation, the camera subsystem of an associated video doorbell (e.g., camera subsystem 329) is configured to utilize 2D coordinate axis 705 to identify the 2D image coordinates of various detected movements. For example, the camera subsystem may utilize 2D coordinate axis 705 to identify the 2D image location of a detected motion event (e.g., tree 707 swaying in the wind).

Trees 707 and 709 represent objects within the environment depicted by scene 701. As such, trees 707 and 709 are representative of exemplary objects, and may instead depict a street sign, a person, an animal, or another object of the like, but for the purposes of explanation, trees will be discussed herein.

In an implementation, a video doorbell associated with scene 701 is configured to determine if a newly detected motion event is a potential motion event or corresponds to a previously detected false alarm event based on the data stored by list 711. List 711 is representative of a buffer, stored in memory (e.g., feedback information buffer 322), which is configured to store the data related to previously detected false alarm events. In an implementation, a video doorbell associated with scene 701 is configured to populate the entries of list 711 with the data of previously detected false alarm events. For example, if the video doorbell is configured to detect human motion, and the video doorbell determines that a detected motion event depicts tree 709 swaying in the wind, then the video doorbell may be configured to populate entry 713 of list 711 with the detected points of the non-human motion event.

In an implementation, list 711 includes multiple entries that are configured to store data of previously detected false alarm events, but for the purposes of explanation, entries 713 and 717 will be discussed herein. This specification is not meant to limit the applications of list 711, but rather to provide an example. In an implementation, entries 713 and 717 each store the detected points of a false alarm event in the form of a cluster. For example, the video doorbell may execute a clustering algorithm, such as dBScan, to form the detected points of a false alarm event into various clusters, herein referred to as data structures 714 and 718.

Data structures 714 and 718 represent clusters of points which correspond to previously detected false alarm events. For example, if the video doorbell is configured to detect human motion, then data structure 714 may store the detected points relating to tree 707 swaying in the wind, while data structure 718 stores the detected points relating to tree 709 swaying in the wind. In an implementation, each data structure detected by the video doorbell includes a centroid, a radius, and a number of detected points within the cluster. For example, data structure 714 includes centroid 715, radius 716, and five detected points, while data structure 718 includes centroid 719, radius 720, and six detected points. During operation, if the video doorbell detects a new false alarm event within the region that is represented by a data structure, then the video doorbell may update the centroid, the radius, and the number of points associated with said data structure to include the detected points of the new false alarm event. In an implementation, data structures 714 and 718 further include the 3D real-world coordinates of the detected points. For example, data structure 714 may store the 3D real-world coordinates of its five detected points, while data structure 718 stores the 3D real-world coordinates of its six detected points.

In an implementation, the video doorbell that is associated with scene 701 is further configured to remove data from list 711 after a certain period of time. For example, after populating a data structure with a newly detected point, the video doorbell may wait a duration of time (e.g., ten minutes), and if no motion events are detected within the data structure within said duration, then the video doorbell may delete the data structure from list 711. To implement this, the video doorbell tracks the period of time a detected point has been stored within an associated data cluster.

In a brief operational scenario, to determine if a newly detected motion event is a potential motion event or a previously detected false alarm event, the radar subsystem of the video doorbell is first configured to transmit and receive radar signals across scene 701. Next, the radar subsystem is configured to process the received radar signals to determine if a motion event occurred within scene 701. If the radar subsystem determines that a motion event occurred, then the radar subsystem is configured to extract data from the received radar signal to determine if the motion event is a potential motion event or a previously detected false alarm event. For example, the radar subsystem may extract a 3D real-world location of the motion event from the received radar signal. Once extracted, the radar subsystem is configured to compare the 3D real-world location of the motion event to the data structures stored in list 711. A motion event is determined to fall within a data structure if the distance of the 3D real-world coordinates of the motion event from the centroid of the data structure is less than or equal to the radius of the data structure. For example, a motion event is determined to fall within data structure 714 when the distance of the 3D real-world coordinates of the motion event from centroid 713 is less than or equal to radius 714.

If the radar subsystem determines that the location of the motion event does not fall within the data structures of list 711 then the radar subsystem is configured to confirm the motion event as a potential motion event. Alternatively, if the radar subsystem determines that the location of the motion event falls within a data structure of list 711, then the radar subsystem is configured to confirm the motion event as corresponding to a previously detected false alarm event and update the respective data structure. In an implementation, if the radar subsystem confirms the motion event as a potential motion event, then the radar subsystem is configured to wake up an associated camera subsystem to cause the associated camera subsystem to determine if the potential motion event is an actual motion event or a new false alarm event. For example, if the video doorbell is configured to detect human motions, then the camera subsystem is configured to determine if the potential motion event is an actual human motion event or a new non-human motion event.

In an implementation, if the camera subsystem determines that the potential motion event is a new false alarm event, then the camera subsystem is configured to provide feedback information related to the new false alarm event to the radar subsystem. For example, the camera subsystem may provide a label of the new false alarm event to the radar subsystem. In response, the radar subsystem may create a new entry within list 711 such that the new entry stores the data structure of the new false alarm event.

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A radar device comprising:
transceiver circuitry configured to transmit and receive radar signals across a scene;
processing circuitry coupled with the transceiver circuitry and configured to:
process a received radar signal to detect a motion event within the scene;
perform a comparison between a location of the motion event and locations of motion events previously detected within the scene; and
confirm that the motion event is one of a false alarm event or a non-false alarm event based on a result of the comparison.

2. The radar device of claim 1, wherein the processing circuitry, to confirm that the motion event is a non-false alarm event based on the result of the comparison, determines that the motion event comprises an actual motion event when the result of the comparison indicates that the location of the motion event does not match any one of the locations of motion events previously detected within the scene.

3. The radar device of claim 2, wherein the motion events previously detected within the scene correspond to false alarm events previously detected within the scene, and wherein the locations correspond to locations of the false alarm events previously detected within the scene.

4. The radar device of claim 3, wherein the processing circuitry is further configured to obtain feedback information from an associated camera, and wherein the feedback information indicates the locations of the false alarm events previously detected within the scene.

5. The radar device of claim 4, wherein the feedback information is associated with signal-to-noise ratios of received radar signals corresponding to the false alarm events.

6. The radar device of claim 5, wherein the radar device further comprises a buffer configured to store the feedback information.

7. The radar device of claim 6, wherein the processing circuitry is further configured to update the buffer with the location of the motion event upon a determination that the motion event is a false alarm event.

8. The radar device of claim 1, wherein the received radar signal is a received low-power radar signal, and wherein the processing circuitry is further configured to, in response to confirming that the motion event is a non-false alarm event based on the result of the comparison:
instruct the transceiver circuitry to transmit and receive high-power radar signals;
process a received high-power radar signal to confirm that the motion event within the scene is a non-false alarm event; and
wake up an associated camera in response to confirming the motion event within the scene is a non-false alarm event based on the received high-power radar signal.

9. The radar device of claim 1, wherein the received radar signal is a received high-power radar signal, and wherein the processing circuitry is further configured to, in response to confirming that the motion event is a non-false alarm event based on the result of the comparison, wake up an associated camera.

10. A system comprising:
host processing circuitry configured to store data representing previous motion events previously classified as false alarm events; and
radar processing circuitry operatively coupled with the host processing circuitry;
wherein the radar processing circuitry is configured to:
process a received radar signal to detect a motion event within the scene;
perform a comparison between the motion event and the stored data representing previous motion events classified by the host processing circuitry as false alarm events; and
classify the motion event based on a result of the comparison.

11. The system of claim 10, wherein the stored data representing previous motion events previously classified as false alarm events includes, for each of the previous motion events, a location of the previous motion event, and wherein the radar processing circuitry, to classify the motion event based on the result of the comparison, determines that the motion event comprises a motion event of interest when the result of the comparison indicates that the location of the motion event does not match any one of the locations of the previous motion events classified by the host processing circuitry as false alarm events.

12. The system of claim 11, wherein the host processing circuitry is further configured to generate feedback information for the false alarm events, and wherein the feedback information indicates the locations.

13. The system of claim 12, wherein the feedback information further indicates signal-to-noise ratios of received radar signals corresponding to the false alarm events.

14. The system of claim 13, wherein the radar processing circuitry includes buffer circuitry configured to store the feedback information.

15. The system of claim 14, wherein the host processing circuitry is further configured to update the buffer circuitry with the location of the motion event upon a determination that the motion event is a false alarm event.

16. The system of claim 10, wherein the system further includes transceiver circuitry coupled with the radar processing circuitry, wherein the received radar signal is a received low-power radar signal, and wherein the radar processing circuitry is further configured to, in response to classifying the motion event as a motion event of interest based on the result of the comparison:
instruct the transceiver circuitry to transmit and receive high-power radar signals;
process a received high-power radar signal to confirm the classification of the motion event within the scene as a motion event of interest; and
wake up an associated camera in response to confirming the classification of the motion event within the scene as a motion event of interest based on the received high-power radar signal.

17. The system of claim 10, wherein the received radar signal is a received high-power radar signal, and wherein the radar processing circuitry is further configured to, in response to classifying the motion event based on the result of the comparison as motion event of interest, wake up an associated camera.

18. A method comprising:
transmitting and receiving radar signals across a scene;
processing a received radar signal to detect a motion event within the scene;
performing a comparison between a location of the motion event and locations of motion events previously detected within the scene; and
classifying the motion event based on a result of the comparison.

19. The method of claim 18, wherein the motion events previously detected within the scene correspond to false alarm events previously detected within the scene, and wherein the locations correspond to locations of the false alarm events previously detected within the scene.

20. The method of claim 19, further comprising obtaining feedback information from an associated camera wherein the feedback information includes the locations of the false alarm events.
